(19) United States
(12) Patent Application Publication
(10) Pub. No.: US 2016/0131316 A1
(43) Pub. Date: May 12, 2016

(54) MODULAR ILLUMINATION SYSTEM

(71) Applicants: Wayne Russell, Ontario, CA (US); Joshua Carton, Wilmington, CA (US); David Barden, Placentia, CA (US)

(72) Inventors: Wayne Russell, Ontario, CA (US); Joshua Carton, Wilmington, CA (US); David Barden, Placentia, CA (US)

(73) Assignee: Power Probe, Inc., Brea, CA (US)

(21) Appl. No.: 14/935,274

(22) Filed: Nov. 6, 2015

Related U.S. Application Data
(60) Provisional application No. 62/077,049, filed on Nov. 7, 2014.

(51) Int. Cl. F21K 99/00; F21V 21/08; F21V 23/04; H05B 37/02; F21V 14/02

(52) U.S. Cl. CPC F21K 9/58; H05B 37/0218; H05B 37/0227; F21V 14/02; F21V 23/0464; F21V 23/0471; F21V 21/08

(57) ABSTRACT

An apparatus and a method are provided for a smart modular illumination system configured to orient and illuminate a plurality of illumination nodes toward a moving object within a target area. The system comprises a controller that signals the illumination nodes when a motion detector observes movement within the target area. The controller refrains from signaling the illumination nodes when ambient light within the target area exceeds a predetermined value. An adjustable mounting member coupled with each of the illumination nodes orients the illumination nodes according to signals received from the controller. The smart modular illumination system is configured to adjust the orientation and brightness of all of the illumination nodes so as to cast light on the moving object from a variety of angles with a reduced occurrence of shadows.

### PRIORITY

This application claims the benefit of and priority to U.S. Provisional Application, entitled “Modular Illumination System,” filed on Nov. 7, 2014, having application Ser. No. 62/077,049.

### FIELD

The field of the present disclosure generally relates to lighting. More particularly, the field of the present disclosure relates to an apparatus and a method for smart motion detection lighting.

### BACKGROUND

In related art, many motion detector lighting devices and systems have been used. For instance, in the realm of outdoor lighting fixtures, wall lamps or wall sconces typically incorporate a built-in motion detector and dusk-to-dawn sensor. However, these related art outdoor lighting fixtures are static or require manual actuation to redispose an orientation of the lighting fixture which may be impracticable in relation to illuminating a large area, wherein the lighting fixture is typically mounted at a high elevation, such as near a top of a garage.

For indoor use, related art indoor lighting fixtures may include motion detector light bulbs, lamps, and the like. While the related art indoor lighting fixtures may automatically turn-on a light when motion is detected and turn-off the light when motion is no longer detected, these related art outdoor lighting fixtures are, likewise, static or require manual actuation to redispose the orientation of the lighting fixture.

However, these related art lighting fixtures do not automatically adjust or readjust a degree of illumination nor an angle of illumination. As such, a long-felt need exists for a smart illumination system.

### SUMMARY

An apparatus and a method are provided for a smart modular illumination system comprising a controller configured to signal a plurality of illumination nodes to cast light on a moving object within a target area. A motion detector is configured to detect movement of the object within the target area and signal the controller when the movement is detected. A dusk-to-dawn sensor is configured to detect a degree of ambient lighting within the target area. When the ambient lighting is greater than a predetermined level, such as during daylight conditions, the controller refrains from signaling the illumination nodes regardless of signals received from the motion detector. An adjustable mounting member coupled with each of the illumination nodes is configured to orient the illumination nodes toward the moving object in response to signals received from the controller. The smart modular illumination system is configured to adjust the orientation and illumination of the illumination nodes so as to cast light on the moving object from a variety of angles, thereby reducing an occurrence of shadows.

In an exemplary embodiment, a smart modular illumination system comprises a controller configured to receive, transmit, and process at least one signal; at least one motion detector, operably coupled with the controller, configured to detect at least one motion and to transmit and receive at least one signal; a plurality of illumination nodes, operably coupled with the controller, configured to transmit and receive at least one signal and to adjustably illuminate; a plurality of adjustable mounting members, operably coupled with the controller, configured to correspondingly couple the plurality of illumination nodes with a surface, the plurality of adjustable mounting members configured to transmit and receive at least one signal and to adjustably dispose the plurality of illumination nodes; and a housing is configured to accommodate at least one of the controller, the at least one motion detector, the plurality of illumination nodes, the plurality of adjustable mounting members, and a dusk-to-dawn sensor.

In another exemplary embodiment, the housing is configured to store, control, charge, and manage the plurality of modular lighting nodes. In another exemplary embodiment, the controller is operable by way of a set of executable instruction stored in a non-transitory computer-readable medium, and wherein the plurality of illumination nodes is adapted to illuminate a target area from a plurality of angles for reducing shadows and increasing visibility in response to the at least one motion.

In another exemplary embodiment, each of the plurality of illumination nodes is configured for use in at least one of a hand-held mode and a work-light mode. In another exemplary embodiment, the controller and the plurality of illumination nodes are powerable by at least one of an internal power source and an external power source, the internal power source comprising at least one of a rechargeable power source and a static power source. In another exemplary embodiment, the controller is configured to operate the plurality of illumination nodes in at least one mode of individually operated and group-wise operated, whereby a degree of illumination directed into a target area is adjustable.

In another exemplary embodiment, the plurality of illumination nodes is powerable by at least one of an internal power source and an external power source, the internal power source being rechargeable by way of the external power source. In another exemplary embodiment, the plurality of illumination nodes is configured to removably and adjustably couple with the housing by at least one feature of a magnet, a clip, and any other adjustable coupling structure. In another exemplary embodiment, the plurality of illumination nodes each comprises at least one of a light-emitting diode (LEDs) and any other illuminating device.

In another exemplary embodiment, the plurality of adjustable mounting members comprises a plurality of adjustable bases for directing illumination at a desired angle. In another exemplary embodiment, any of the controller, the at least one motion detector, the plurality of illumination nodes, and the plurality of adjustable mounting members are configured to transmit and receive at least one signal in at least one manner of by-wire and wirelessly.

In an exemplary embodiment, a method of fabricating a smart modular illumination system comprises providing a controller configured to receive, transmit, and process at least one signal; providing at least one motion detector, operably coupled with the controller, configured to detect at least one motion and to transmit and receive at least one signal; providing a plurality of illumination nodes, operably coupled with the controller, configured to transmit and receive at least one signal and to adjustably illuminate; and providing a plurality of adjustable mounting members, operably coupled with the controller, configured to correspondingly couple the plurality of illumination nodes with a surface, the plurality of adjustable mounting members configured to transmit and receive at least one signal and to adjustably dispose the plurality of illumination nodes.

In another exemplary embodiment, the method further comprises providing a housing for accommodating at least one of the controller, the at least one motion detector, the plurality of illumination nodes, the plurality of adjustable mounting members; and providing a dusk-to-dawn sensor, operably coupled with the controller, configured to detect at least one motion and to transmit and receive at least one signal.

In an exemplary embodiment, a method of illuminating a target area by way of a smart modular illumination system comprises providing the smart modular illumination system comprising a plurality of illumination nodes, each of which illumination nodes being adjustably supported by way of an adjustable mounting member; powering the smart modular illumination system; detecting at least one motion within the target area; adjusting an illumination of at least one of the plurality of illumination nodes; and adjusting an orientation of the at least one of the plurality of illumination nodes by way of the adjustable mounting member; thereby reducing shadows and increasing visibility in the target area in response to the at least one motion.

In another exemplary embodiment, providing the smart modular illumination system further comprises providing a controller configured to receive, transmit, and process at least one signal; providing at least one motion detector, operably coupled with the controller, configured to detect the at least one motion and to transmit and receive at least one signal; providing the plurality of illumination nodes, operably coupled with the controller, configured to transmit and receive at least one signal and to adjustably illuminate; providing a plurality of adjustable mounting members, operably coupled with the controller, configured to correspondingly couple the plurality of illumination nodes with a surface, the plurality of adjustable mounting members configured to transmit and receive at least one signal and to adjustably orient the plurality of illumination nodes; providing a housing configured to accommodate at least one of the controller, the at least one motion detector, the plurality of illumination nodes, and the plurality of adjustable mounting members; and providing a dusk-to-dawn sensor, operably coupled with the controller, configured to detect a degree of ambient light within the target area; wherein the controller is operable by way of a set of executable instruction stored in a non-transitory computer-readable medium.

### BRIEF DESCRIPTION OF THE DRAWINGS

The drawings refer to embodiments of the present disclosure in which:

FIG. 1 is a schematic diagram illustrating an exemplary embodiment of a smart modular illumination system, in accordance with the present disclosure;

FIG. 2 is a flowchart illustrating an exemplary method of fabricating a smart modular illumination system, in accordance with the present disclosure; and

FIG. 3 is a flowchart illustrating an exemplary method of illuminating a target area by way of a smart modular illumination system, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first system,” may be made. However, the specific numeric reference should not be interpreted as a literal sequential order but rather interpreted that the “first system” is different than a “second system.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure provides an apparatus and a method for a smart modular illumination system configured to orient and illuminate a plurality of illumination nodes toward a moving object within a target area. The plurality of illumination nodes may comprise light emitting diodes (LEDs), as well as any other suitable source of lighting. The system comprises a controller that signals the illumination nodes when a motion detector observes movement within the target area. The controller refrains from signaling the illumination nodes when ambient light within the target area exceeds a predetermined level. An adjustable mounting member coupled with each of the illumination nodes orients the illumination nodes according to signals received from the controller. The illumination nodes and the adjustable mounting members may be coupled with the controller by way of either by-wire connections or wireless connections. The smart modular illumination system is configured to adjust the orientation and brightness of all of the illumination nodes so as to cast light on the moving object from a variety of angles with a reduced occurrence of shadows.

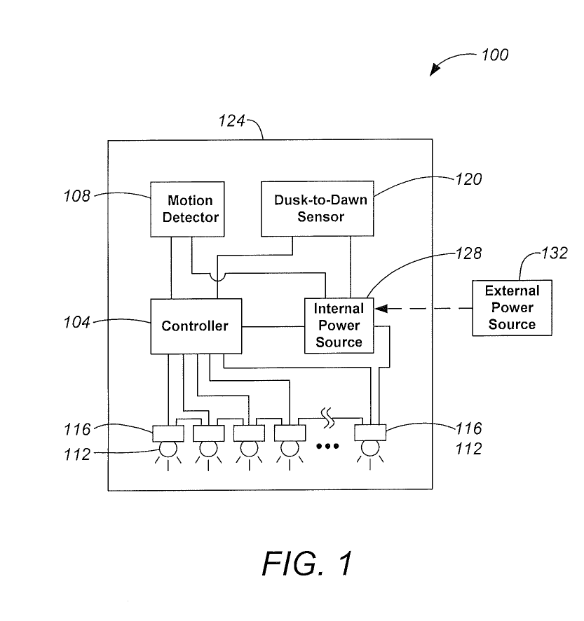

FIG. 1 is a schematic diagram illustrating an exemplary embodiment of a smart modular illumination system 100, in accordance with the present disclosure. The system 100 generally comprises a controller 104 that is operably coupled with at least one motion detector 108 and a plurality of illumination nodes 112 so as to control a degree of illumination of a targeted area. The illumination nodes 112 preferably are comprised of one or more light-emitting diodes (LEDs), or any other illuminating device suitable for lighting the target area.

In the embodiment illustrated in FIG. 1, the controller 104 is configured to send one or more signals to operate the plurality of illumination nodes 112 in response to one or more signals received from the motion detector 108. The controller 104 generally comprises one or more microprocessors configured to execute instructions, stored on a non-transitory machine readable medium (i.e., a memory), that cause the controller to operate the plurality of illumination nodes 112, as described herein. In operation, the controller 104 directs the illumination nodes 112 to adjustably illuminate the target area when movement of an object is detected within the area by the motion detector 108. As such, each of the plurality of illumination nodes 112 is coupled with an adjustable mounting member 116 whereby the controller 104 may adjust an orientation of each of the illumination nodes 112. Thus, when movement of an object is detected within the target area by way of the motion detector 108, the controller 104 may direct the illumination nodes 112 toward the object by way of the adjustable mounting members 116.

The controller 104 may adjust the degree of illumination by operating the illumination nodes 112 in at least one of an individually operated mode and a group-wise operated mode so as to adjustably illuminate the target area. In the individually operated mode, the controller 104 may change the orientation of individual illumination nodes 112 so as to adjust the degree of illumination within the target area. In the group-wise operated mode, the controller 104 may change the orientations of the plurality of illumination nodes 112. It is envisioned that, in some embodiments, the controller 104 may adjust the orientations of the illumination nodes 112 in unison, such that the illumination nodes move simultaneously in the same direction. For example, the controller 104 may cause all of the illumination nodes 112 to be panned rightward or leftward to illuminate an area where motion is detected. Further, in some embodiments, the controller 104 may simultaneously adjust the orientations of the illumination nodes 112 in different directions. For instance, the controller 104 may cause the plurality of illumination nodes 112 to cooperatively illuminate a specific location where movement is detected within the target area. Thus, the plurality of illumination nodes 112 cast light on the specific location from a plurality of different angles. As will be appreciated, directing the plurality of illumination nodes 112 to the specific location at a plurality of angles reduces an instance of shadows that would otherwise occur with the illumination nodes 112 oriented in the same direction. Further, orienting the illumination nodes toward the specific location increases visibility, as well as improving movement detection accuracy.

In the embodiment illustrated in FIG. 1, the smart modular illumination system 100 comprises a dusk-to-dawn sensor 120 that is operably coupled with the controller 104 and the plurality of illumination nodes 112. The dusk-to-dawn sensor 120 is configured to detect a degree of ambient lighting in the proximity of the system 100 and send at least one corresponding signal to the controller. In some embodiments, the dusk-to-dawn sensor 120 may signal the controller 104 to ignore signals received from the motion detector 108 when the ambient lighting is found to be greater than a predetermined level, such as during daylight hours. In other embodiments, the dusk-to-dawn sensor 120 may operate as a switch that remains open in response to ambient lighting greater than the predetermined level, thereby preventing signals from the controller 104 reaching the plurality of illumination nodes 112. As will be appreciated, the dusk-to-dawn sensor 120 prevents activation of the plurality of illumination nodes 112 during times when illumination of the target area is unnecessary, thereby reducing electricity costs associated with operating the smart modular illumination system 100.

The smart modular illumination system 100 further comprises a housing 124 that serves as a mechanical envelope for at least the controller 104, the motion detector 108, the dusk-to-dawn sensor 120, and associated circuitry. It will be recognized that the housing 124 provides a protective envelope for those certain components and circuitry comprising the smart modular illumination system 100. In the illustrated embodiment of FIG. 1, the plurality of illumination nodes 112 are coupled with the housing 124 by way of the adjustable mounting members 116. As will be appreciated, each of the adjustable mounting members 116 comprises essentially an adjustable base for directing light from each of the illumination nodes 112 at a desired angle. In some embodiments, each of the adjustable mounting members 116 may be removably coupled with the housing 124 by way of any of a magnet, a clip, as well as any other adjustable coupling structure.

As will be appreciated, the housing 124 provides a surface whereby the adjustable mounting members 116 may be supported. In one embodiment, each of the illumination nodes 112 may be removable from the surface of the housing 124. For example, each of the illumination nodes 112 may be configured to operate in at least one of a hand-held mode and a work-light mode. In the hand-held mode, it is envisioned that any of the illumination nodes 112 may be removed from the surface of the housing 124 by hand so as to manually direct illumination toward the target area. In the work-light mode, one or more of the illumination nodes 112 may be manually positioned at different locations around a work site, as desired, so as to provide illumination to the work site from a plurality of angles. It is envisioned that in the work-site mode, the modular illumination system 100 may direct illumination to a specific location within the work site where movement is taking place, thereby reducing an instance of shadows that may otherwise occur.

In the embodiment illustrated in FIG. 1, an internal power source 128 is disposed within the housing 124 and configured to supply electrical power to the components and circuitry comprising the smart modular illumination system 100. In some embodiments, however, the system 100 may be coupled with an external power source 132, such as an AC wall socket or other similar source of electrical power. As will be appreciated, the housing 124 preferably comprises a socket configured to receive a power cord extending from the external power source 132, as well as internal electrical circuitry configured to receive electrical power from the external power source 132. In some embodiments, the internal power supply 128 may comprise an internal rechargeable battery that may be charged by way of the external power source 132. Still, in some embodiments, the external power source 132 may provide electrical power to the plurality of illumination nodes 112 while the internal rechargeable battery provides electrical power to one or more of the controller 104, the motion detector 108, the adjustable mounting members 116, and the dusk-to-dawn sensor 120. In some embodiments, the external power source 132 may simultaneously charge the internal rechargeable battery and supply electrical power to one or more of the controller 104, the motion detector 108, the illumination nodes 112, the adjustable mounting members 116, and the dusk-to-dawn sensor 120. Other techniques for coupling the internal power source and the external power source with the smart modular illumination system 100 will be apparent to those skilled in the art without deviating beyond the scope and spirit of the present disclosure.

As shown in the embodiment of FIG. 1, electrical wires are disposed within the housing 124 to convey electric signals among at least the motion detector 108, the dusk-to-dawn sensor 120, the controller 104, the illumination nodes 112, and the adjustable mounting members 116. It is contemplated, however, that in some embodiments one or more of the motion detector 108, the dusk-to-dawn sensor 120, the controller 104, the illumination nodes 112, and the adjustable mounting members 116 may be configured to transmit and receive at least one signal by way of wireless connections, such as Wi-Fi, Bluetooth, or other similar wireless connections. For example, in one embodiment the controller 104 and the plurality of adjustable mounting members may be configured to communicate wirelessly so as to facilitate positioning of the illumination nodes 112 at various remote distances from the controller 104 without any need for considering the lengths of electrical wires. Further, in some embodiments each of the illumination nodes 112 may comprise an internal power source, such as a rechargeable battery, so as to facilitate placing individual illumination nodes 112 in various remote locations without any need for routing wires from the individual illumination nodes to either the controller 104 or the internal power source 128. It is contemplated that in such embodiments, the rechargeable batteries may be recharged upon returning the individual illumination nodes 112 to default locations on the surface of the housing 124. It should be understood that communications between at least a portion of all those certain components comprising the smart modular illumination system 100 may be implemented by way of various by-wire or wireless connections, without limitation, and without deviating beyond the spirit and scope of the present disclosure.

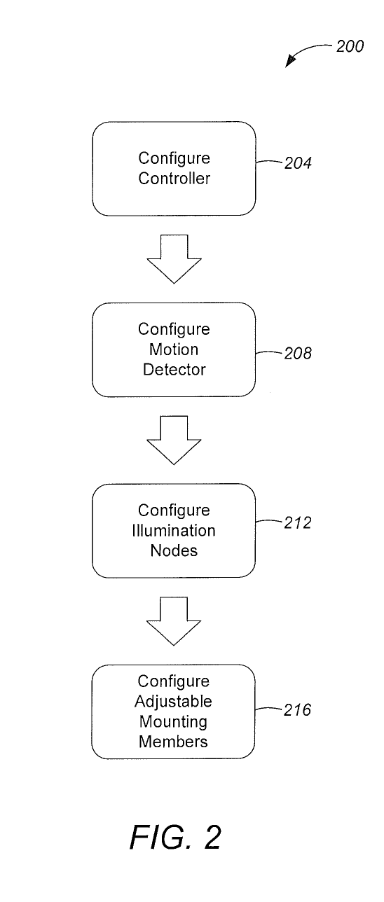

FIG. 2 is a flowchart illustrating an exemplary method 200 for fabricating a smart modular illumination system 100, in accordance with the present disclosure. The method 200 begins with a step 204 comprising configuring a controller 104 to receive, process, and transmit one or more signals that are suitable for operating the smart modular illumination system 100, as described herein. Step 204 may further comprise storing instructions on a non-transitory machine-readable medium (i.e., a memory) that, when executed by one or more microprocessors comprising the controller, cause the controller to transmit one or more signals suitable for operating a plurality of illumination nodes 112, as described herein. Preferably, step 204 further comprises disposing the controller 104 within a housing 124 that serves as a protective mechanical envelope.

A step 208 comprises configuring a motion detector 108 to detect movement within a detection field, or a target area, and to transmit at least one signal in response to detected movement. Step 208 further comprises forming a connection between the motion detector 108 and the controller 104, such that the motion detector transmits at least one signal to the controller 104 when movement is observed within the target area. Further, step 208 may comprise forming a connection between the controller 104 and a dusk-to-dawn sensor 120, such that the dusk-to-dawn sensor 120 may signal the controller 104 to ignore signals received from the motion detector 108 when the ambient lighting is greater than a predetermined level, such as during daylight hours. The connection may be implemented by way of various by-wire or wireless connections, without limitation.

A step 212 comprises configuring a plurality of illumination nodes 112 to receive and transmit at least one signal and to adjustably illuminate. Step 212 further comprises establishing a connection between each of the plurality of illumination nodes 112 and the controller 104, such that the illumination nodes 112 adjustably illuminate in response to one or more signals received from the controller 104. Further, step 212 may comprise configuring the plurality of illumination nodes 112 to be removably supported by the housing 124 and usable in at least one of a hand-held mode and a work-light mode, as described above. In some embodiments, step 212 comprises installing an internal power source, such as a rechargeable battery, within each of the illumination nodes and configuring a wireless connection between the illumination nodes and the controller, such that the illumination nodes 112 may be positioned remotely from the controller 104. Further still, step 212 may comprise configuring default locations for the illumination nodes 112 on a surface of the housing 124 whereby the internal power sources of the illumination nodes may be recharged.

As shown in FIG. 2, the method 200 concludes with a step 216 comprising configuring a plurality of adjustable mounting members 116 to receive and transmit at least one signal and to adjustably orient each of the illumination nodes 112. Step 216 further comprises establishing a connection between the plurality of adjustable mounting members 116 and the controller 104, such that each of the adjustable mounting members orients a corresponding illumination node 112 according to signals received from the controller 104. In some embodiments, step 216 may comprise configuring each of the adjustable mounting members 116 to be coupled with the housing 124 by way of any of a magnet, a clip, as well as any other adjustable coupling structure.

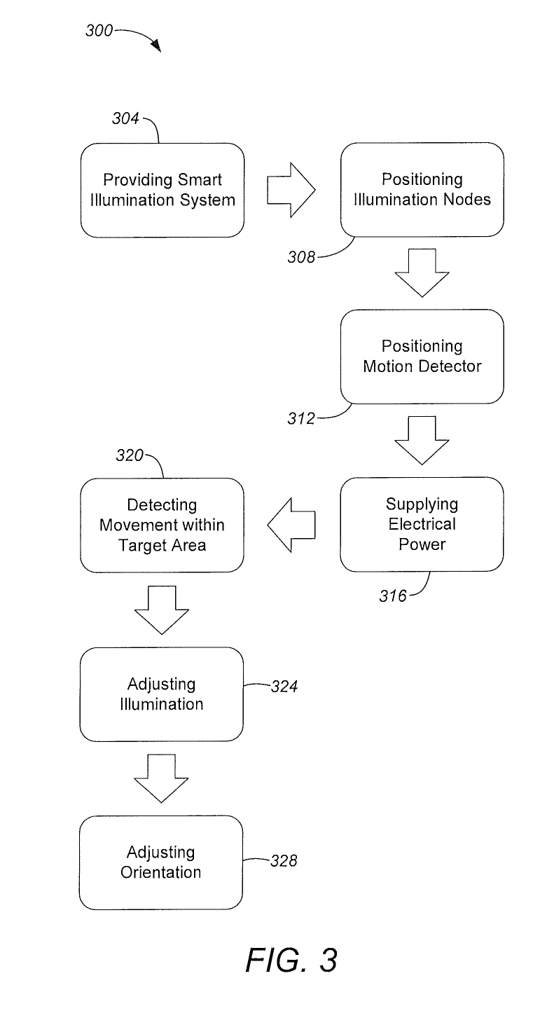

FIG. 3 is a flowchart illustrating an exemplary method 300 of illuminating a target area by way of a smart modular illumination system 100, according to the present disclosure. The method 300 begins at a step 304 comprising providing the smart modular illumination system 100. The step 304 may comprise the method 200 discussed with respect of FIG. 2, or may comprise any substantially equivalent method for fabricating the smart modular illumination system 100. For example, in some embodiments the smart modular illumination system 100 may comprise wired connections between at least the controller 104 and the plurality of illumination nodes 112, whereas in some embodiments the smart modular illumination system 100 may comprise wireless connections between at least the controller 104 and the plurality of illumination nodes 112. Other equivalent methods for fabricating the smart modular illumination system 100 will be apparent to those skilled in the art without deviating from the present disclosure.

A step 308 comprises positioning the plurality of illumination nodes 112 in locations near the target area. It is contemplated that the illumination nodes 112 may be advantageously positioned so as to illuminate the target area from a variety of different angles, thereby substantially reducing an occurrence of shadows within the target area. In some embodiments, the illumination nodes 112 may be coupled with the housing 124 so as to illuminate the target area from a relatively centralized location. In some embodiments, wherein the smart modular illumination system 100 comprises wired connections between the controller 104 and the plurality of illumination nodes 112, the illumination nodes may be disposed in various locations around and within the target area, as permitted by the lengths of the wires. In some embodiments, wherein the illumination nodes 112 are wirelessly connected to the controller 104, the illumination nodes may be positioned remotely from the controller so as to substantially surround the target area.

A step 312 comprises positioning the motion detector 108 in a location suitable for observing movement of objects within the target area. Step 312 further comprises positioning the dusk-to-dawn sensor 120 in a location suitable for detecting an ambient lighting of the target area. As will be appreciated, in embodiments of the smart modular illumination system 100 comprising wireless connections, the motion detector 108 and the dusk-to-dawn sensor 120 may be positioned remotely from the controller 104 so as to advantageously detect movement and ambient lighting within the target area without a burden of routing wires around or within the target area.

Once the smart modular illumination system 100 is advantageously assembled near the target area, as discussed in connection with the above steps, the method 300 advances to a step 316 comprising supplying electrical power to the system 100. In some embodiments, the system 100 may be coupled with an external power source 132, such as an AC wall socket or other similar source of electrical power. In absence of an external power source 132, however, step 316 may comprise charging an internal power source 128 of the system 100. In some embodiments, wherein the plurality of illumination nodes 112 each comprises an internal battery, step 316 may comprise charging the internal batteries by way of either or both of the internal power source 128 and the external power source 132, as needed.

Once the smart modular illumination system 100 is assembled near the target area and receiving electrical power, as described in step 316, the method 300 advances to a step 320 comprising detecting movement of at least one object within the target area. Once movement is observed, the motion detector 108 transmits at least one signal to the controller 104. So long as the ambient lighting is below a predetermined level, as detected by way of the dusk-to-dawn sensor 120, the controller 104 processes signals received from the motion detector 108 and then transmits at least one signal to each of the plurality of illumination nodes 112 and at least one signal to each of the adjustable mounting members 116, as described above.

A step 324 comprises receiving at least one signal from the controller 104 and adjusting the illumination, or brightness, of at least one of the plurality of illumination nodes 112 in response to the signal. In some embodiments, the illumination may be adjusted to a predetermined degree so as to cast a desired level of light on the object moving within the target area. In some embodiments, the illumination may be switched from an initial off-state to an on-state so as to cast light on the moving object. Preferably, however, the controller 104 signals all of the plurality of illumination nodes 112 is such a manner to desirably illuminate the moving object from a variety of different angles.

The method 300 concludes with a step 328 comprising receiving at least one signal from the controller 104 and adjusting the orientation of at least one of the plurality of illumination nodes 112 by way of the adjustable mounting member 116 coupled therewith. In some embodiments, the controller 104 signals a portion of the plurality of adjustable mounting members 116 while not signaling a remaining portion of the adjustable mounting members. Thus, the system 100 may orient a portion of the illumination nodes 112 directly toward the moving object while leaving the remaining portion of the illumination nodes in a previous orientation. In some embodiments, however, the controller 104 signals all of the plurality of adjustable mounting members 116 so as to orient all of the illumination nodes 112 toward the moving object so as to cast light on the object with a reduced occurrence of shadows. The step 328 may further comprise the controller 104 transmitting at least one signal to all or a portion of the plurality of illumination nodes 112 so as to turn off the illumination nodes after a predetermined time period has elapsed.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A smart modular illumination system, comprising:
a controller configured to receive, transmit, and process at least one signal;
at least one motion detector, operably coupled with the controller, configured to detect at least one motion and to transmit and receive at least one signal;
a plurality of illumination nodes, operably coupled with the controller, configured to transmit and receive at least one signal and to adjustably illuminate;
a plurality of adjustable mounting members, operably coupled with the controller, configured to correspondingly couple the plurality of illumination nodes with a surface, the plurality of adjustable mounting members configured to transmit and receive at least one signal and to adjustably dispose the plurality of illumination nodes; and
a housing configured to accommodate at least one of the controller, the at least one motion detector, the plurality of illumination nodes, the plurality of adjustable mounting members, and a dusk-to-dawn sensor configured to detect a level of ambient light.

2. The system of claim 1, wherein the housing is configured to store, control, charge, and manage the plurality of illumination nodes.

3. The system of claim 1, wherein the controller is operable by way of a set of executable instructions stored in a non-transitory machine-readable medium, and wherein the plurality of illumination nodes is adapted to illuminate a target area from a plurality of angles for reducing shadows and increasing visibility in response to the at least one motion.

4. The system of claim 1, wherein each of the plurality of illumination nodes is configured for use in at least one of a hand-held mode and a work-light mode.

5. The system of claim 1, wherein the controller and the plurality of illumination nodes are powerable by at least one of an internal power source and an external power source, the internal power source comprising at least one of a rechargeable power source and a static power source.

6. The system of claim 1, wherein the controller is configured to operate the plurality of illumination nodes in at least one mode of individually operated and group-wise operated, whereby a degree of illumination directed into a target area is adjustable.

7. The system of claim 1, wherein the plurality of illumination nodes is powerable by at least one of an internal power source and an external power source, the internal power source being rechargeable by way of the external power source.

8. The system of claim 1, wherein the plurality of illumination nodes is configured to removably and adjustably couple with the housing by at least one of a magnet, a clip, and any other adjustable coupling structure.

9. The system of claim 1, wherein the plurality of illumination nodes each comprises at least one of a light-emitting diode (LEDs) and any other illuminating device.

10. The system of claim 1, wherein the plurality of adjustable mounting members comprises a plurality of adjustable bases for directing illumination at a desired angle.

11. The system of claim 1, wherein any of the controller, the at least one motion detector, the plurality of illumination nodes, and the plurality of adjustable mounting members are configured to transmit and receive at least one signal in at least one manner of by-wire and wirelessly.

12. A method of fabricating a smart modular illumination system, comprising:
providing a controller configured to receive, transmit, and process at least one signal;
providing at least one motion detector, operably coupled with the controller, configured to detect at least one motion and to transmit and receive at least one signal;
providing a plurality of illumination nodes, operably coupled with the controller, configured to transmit and receive at least one signal and to adjustably illuminate; and
providing a plurality of adjustable mounting members, operably coupled with the controller, configured to correspondingly couple the plurality of illumination nodes with a surface, the plurality of adjustable mounting members configured to transmit and receive at least one signal and to adjustably dispose the plurality of illumination nodes.

13. The method of claim 12, further comprising:
providing a housing for accommodating at least one of the controller, the at least one motion detector, the plurality of illumination nodes, and the plurality of adjustable mounting members; and
providing a dusk-to-dawn sensor, operably coupled with the controller, configured to detect at least an ambient light level and to transmit and receive at least one signal.

14. A method of illuminating a target area by way of a smart modular illumination system, comprising:
providing the smart modular illumination system comprising a plurality of illumination nodes, each of which illumination nodes being adjustably supported by way of an adjustable mounting member;
powering the smart modular illumination system;
detecting at least one motion within the target area;
adjusting an illumination of at least one of the plurality of illumination nodes; and
adjusting an orientation of the at least one of the plurality of illumination nodes by way of the adjustable mounting member;
thereby reducing shadows and increasing visibility in the target area in response to the at least one motion.

15. The system of claim 14, wherein providing the smart modular illumination system further comprises:
providing a controller configured to receive, transmit, and process at least one signal;
providing at least one motion detector, operably coupled with the controller, configured to detect the at least one motion and to transmit and receive at least one signal;
providing the plurality of illumination nodes, operably coupled with the controller, configured to transmit and receive at least one signal and to adjustably illuminate;
providing a plurality of adjustable mounting members, operably coupled with the controller, configured to correspondingly couple the plurality of illumination nodes with a surface, the plurality of adjustable mounting members configured to transmit and receive at least one signal and to adjustably orient the plurality of illumination nodes;
providing a housing configured to accommodate at least one of the controller, the at least one motion detector, the plurality of illumination nodes, and the plurality of adjustable mounting members; and
providing a dusk-to-dawn sensor, operably coupled with the controller, configured to detect a degree of ambient light within the target area;
wherein the controller is operable by way of a set of executable instructions stored in a non-transitory machine-readable medium.
